(19) United States
(12) Patent Application Publication
(10) Pub. No.: US 2006/0195322 A1
(43) Pub. Date: Aug. 31, 2006

(54) System and method for detecting and storing important information

(76) Inventors: Scott J. Broussard, Cedar Park, TX (US); Eduardo N. Spring, Round Rock, TX (US)

Correspondence Address: Greg Goshorn, P.C., 9600 Escarpment, auite 745-9, AUSTIN, TX, 78749, US

(21) Appl. No.: 11/060,609

(22) Filed: Feb. 17, 2005

(51) Int. Cl. G10L 21/00; H04R 29/00; H04R 3/00; G10L 19/00; G10L 17/00

(52) U.S. Cl. 704/270; 704/201; 704/246; 381/56; 381/110

(57) ABSTRACT

Provided is an improved method for recording audio notes for easier later retrieval. The system monitors audio input and recommends recording of an extended audio segment based on detection of audio triggers. If the user accepts the recommendation, the use is provided with the opportunity to record a segment name. Segment names are recorded with links to the extended audio segment. Later review of segment names eases retrieval of extended audio segment with desired content.

### TECHNICAL FIELD

The present invention relates generally to storage of spoken information for subsequent retrieval.

### BACKGROUND OF THE INVENTION

International Business Machines Corp. (IBM) of Armonk, N.Y. has been at the forefront of new paradigms in business computing. One particular area of development has been in the development of personal assistance devices which serve to aid or supplement a user's memory—for example, cell phones, PDAs (personal digital assistant) and other memory devices. One particular area of development has been the audio recording of speech in such devices. Such improvements have used digital audio recording technology improvements including compression of digital audio recording to improve the storage capacity of a digital recording device by recognizing silence. Recognition of silence enables ignoring this information thus compressing the amount of information to record or otherwise treating it in a manner that decreases the overall size of the audio file. Improvements have been made in recognizing silence distinguishing between background noise and audio that the user desires to have captured. Recognizing silence has also been used to initiate or terminate a recording session.

One major limitation of these prior art devices lies in the inefficiency of retrieving information stored in this manner. Improved storage of audio-recorded information for easier retrieval is desired.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram of major components of the present system;

FIG. 2 is a block diagram of major components of the processing and storage unit illustrated in FIG. 1;

FIG. 3 is a block diagram of major signal processing components of the present system and method;

FIG. 4 is in flowchart illustration the decision flow of one embodiment of the present system and method; and

FIG. 5 is a flowchart illustration of one embodiment for setting the audio detection triggers used in the flowchart illustrated in FIG. 4.

### DETAILED DESCRIPTION

Although described with particular reference to a memory assistance device, the claimed subject matter can be implemented in any electronic system in which it is desired to record speech into more easily accessible formats. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

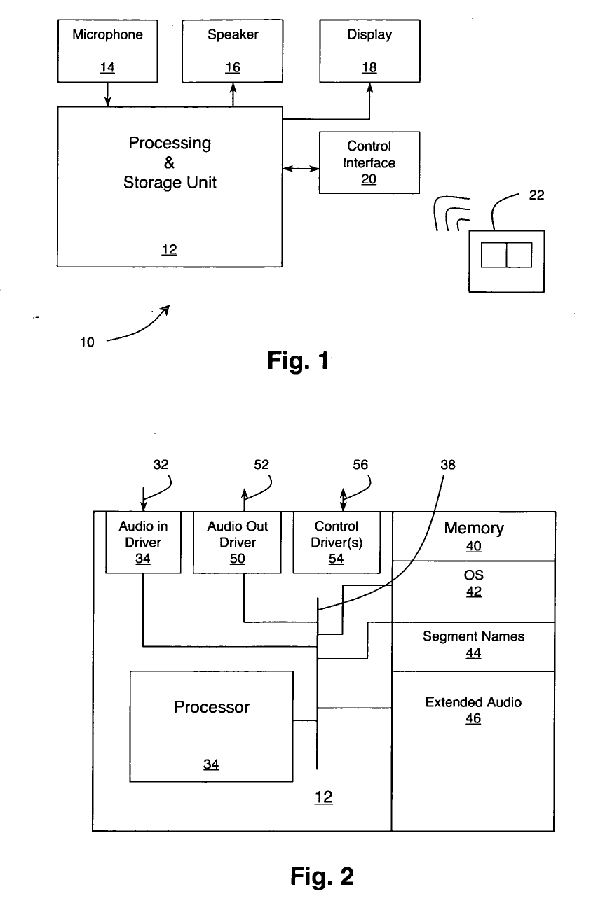

Turning now to the figures, FIG. 1 is a block diagram of an exemplary system for employing the present invention. FIG. 1 illustrates a memory assistance device 10. The heart of the devices is a processing and storage unit 12. The Processing and storage unit 12 has direct or indirect access to a microphone 14 for receiving audio input. In some embodiments the microphone could be an auxiliary or peripheral device. Likewise the processing and storage unit 12 preferably would have access to a speaker system 16 for converting an electronic audio signal in to an auditory signal (sound). The speaker system 16 is not strictly necessary to input data. However, it would be necessary for later retrieval of the stored audio content in a form usable to the user's ear. In some embodiments the speaker system would be auxiliary to processing and storage unit so that the speaker system 16 is only plugged in when desired.

In most of the embodiments described herein the speaker system 16 is also employed to cue the user as will be described in greater detail below. The speaker system 16 may also be used to alert the user about system status—such as an alert that the memory is full or near full. FIG. 1 also illustrates a visual output 18. This visual output 18 can take many forms and can provide various levels of system status information to the user. It may indicate that the system is active; it may cue the user for input in addition to or independent from the speaker system as mentioned above. In some embodiments the visual output could be a simple light like an LED or a set of LED's or Mulitcolor LED's. The lights may or not have variable or multiple intensity levels. In alternative embodiments the display could generate alphanumeric and or graphical information. Although not illustrated in FIG. 1 the system 10 may include a physical output that provides a physical alert to the user such as a vibration or mild electrical tingle.

The system illustrated in FIG. 1 also includes a control interface 20. The control interface 20 can also take many forms. The simplest form is a simple toggle tap switch which generates a single pulse input when tapped by the user. Alternative more sophisticated mechanical or electronic controls would be used in other embodiments of the system. In an embodiment of the system not shown the control interface would employ the use of a wireless control interface that communicates with a remote control unit 22. In any case, it is important that the control interface be capable of receiving input from the user.

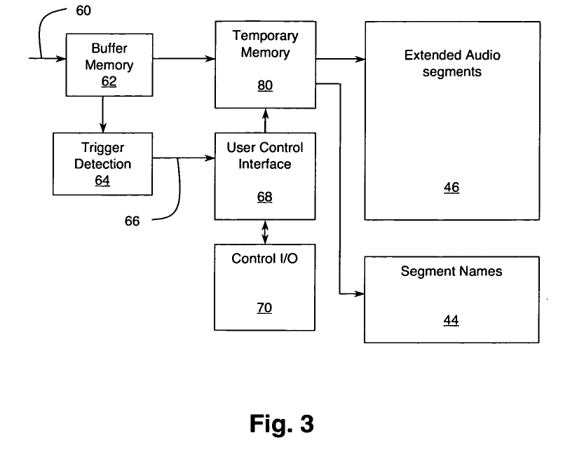

FIG. 2 is a block diagram of major components of the processing and storage unit 12. Many of the components illustrated in FIG. 2 and described below can be implemented in software, firmware, or hardware or combinations thereof. Typically the device would be powered by a battery or some other power source (not shown). The unit system would either have to receive the analog signal in digital form or have an analog to Digital (A to D) converter 32 which makes the data available to a data processor 34 possibly through a data bus 38 as shown in the FIG. 2. The unit also has memory 40 for storing the operating system 42 extended audio segments 46 and segment names 44. The operating system 42 runs the system. Salient features of the operating system 42 for the purposes of this invention are described in greater detail herein.

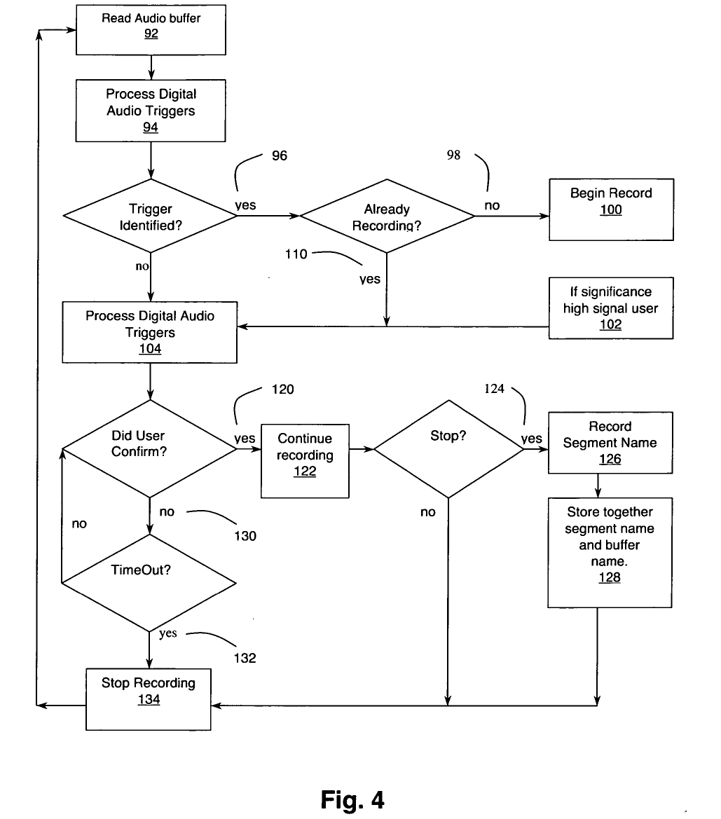

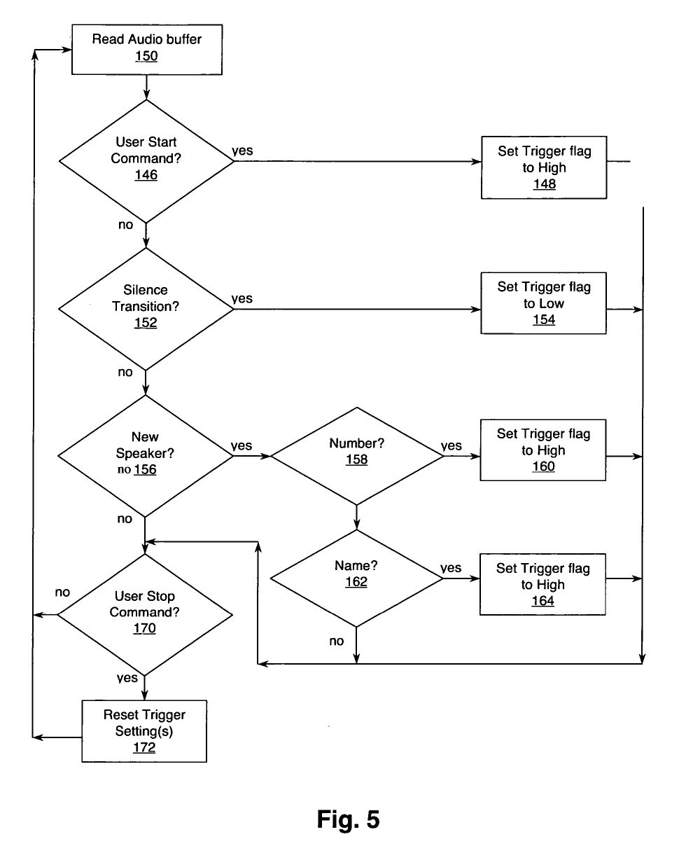

Typically an extended audio segment 46 is directly associated with a segment name 44. In practice these segment names 44 serve like a table of contents or index for the extended segments 46. By scanning the segment names 44 the user can more readily identify an extended audio segment that contains information that the user desires to retrieve. Systems and methods for populating the extended segments and segment names are described in greater detail in reference to FIG. 3, FIG. 4, and FIG. 5.

The unit 12 illustrated in FIG. 2 also includes a digital to analog converter or audio out driver 50 for converting a digital audio signal into a signal 52 to drive an audio speaker (not shown in this figure) for converting the audio signal into an auditory signal (sound). Like the speaker 16 in FIG. 1, this portion is not necessary for populating the extended audio segments and segment names but is preferable for complete system usability for user retrieval of information in the segment names and extended audio signals.

FIG. 2 also illustrates a control driver(s) 54 for interfacing with control inputs and outputs such as the control interface 20 shown in FIG. 1 and output such as the display 18 also shown in FIG. 1. The control interface driver 54 may provide bi-directional communication with some of the devices with which it interfaces. In other cases, the interface driver may provide for uni-directional communication either into the unit 12 or out of the unit 12.

FIG. 3 provides a block diagram of major system architectural signal processing components of the present system and method. After having been converted to a digital audio signal as previously described, the audio signal 60 enters a buffer memory 62. A trigger detection subsystems 64 uses the data in the buffer 62 to look for triggers in the data that indicate that the incoming signal contains information which should be recorded in a separate extended audio segment. Examples of these triggers are described in greater detail in FIG. 5 and associated descriptions below. If triggers are detected, a signal 66 is sent to the user control interface 68 which provides feedback to the user though the control input/output 70 that the system recommends starting to record a new audio segment. If the user assents by inputting a affirmative response in the control I/0 70, then the control interface 68 signals that the data in and flowing through the buffer memory 62 be recorded into a temporary memory section 80 and through to an Extended audio segment 46.

Meanwhile the trigger detection system 64 continues to assess the information coming into the buffer 62 and the user control interface 68 continues to monitor for input from the user. After the section is done recording either by instruction from the user or firing of a new trigger, then the user is prompted by the user control interface 68 via the control I/O to record a segment name 44. While the segment name is recorded trigger detection 64 is ignored. In some embodiments the segment name is mapped to the extended segment memory 46 that has just been place in a memory location. In other embodiments both the segment name and the extended audio signal are recorded in their respective memory locations after the segment name has been recorded and placed in the temporary memory. However, in any case, it is preferable that the segment name is mapped directly to its corresponding extended audio segment. In some devices the extended memory segments and segment names are stored in the same memory device as illustrated in FIG. 2. In other embodiments the extended memory segments and segment names are stored in separate memory devices.

FIG. 4 and FIG. 5 illustrate the program flow of one embodiment of the trigger detection system. The audio buffer 62 is read 92 and processed 94 by the digital audio trigger detection routine(s) (an example of which is illustrated in FIG. 5). If a trigger has been identified 96 and if the system is not already recording 98 then the temporary memory 80 begins to record 100 data in and coming through the buffer 62; and, if the trigger significance value is above a predetermined value 102, then a signal is generated to alert the user; and the recording begins to be stored 104 in the temporary memory 80.

If the trigger is identified 96 and the system is already recording 110, then the recording continues to be stored in the temporary memory 80.

Whether or not the trigger is identified the buffer continues to be read 92 and processed 94 by the audio trigger detection routine(s).

While the audio signal is being stored 104 in the temporary memory 80, the system is waiting for the user to reply to the user prompt and confirm whether to continue storing the audio recording. If the user confirms 120 then the recording and storage continues 122 until a stop-input command is entered by the user 124. If a stop-input is entered by the user 124, then the user is prompted to record a segment name 126 and the user name is recorded and stored 128 linked/mapped to the extended audio segment in the system memory. Although not shown in this figure, the preferred embodiment includes a timeout that signals the user to prompt the device if the user wants the system to continue recording information in the temporary buffer after a predetermined time limit. If so, the system begins to store the temp file in memory to make more room in the temp file. In other embodiments the user is prompted to record a segment name and forced to start a new segment if he/she wants to continue recording.

If the user does not prompt the device to proceed with recording 130, and a predetermined period of time passes 132 then the system stops recording and the temporary memory is cleared 134

FIG. 5 is an illustration of an embodiment of program flow for an audio trigger detection routine. First the digital audio signal from the audio buffer is retrieved 150. If at any time the user inputs a record command 146, a detection significance flag is set to high to trigger the main routines to begin recording.

If there is no begin record command the audio trigger detection program applies a routine for detecting a silence transition in speech 152. Routines for detecting silence transitions are well known in the art. It is preferable to use a routine that accounts for back ground noise in determining such transitions such routines are also well known in the art. See for example U.S. Pat. Nos. 4,130,739; and 6,029,127. If a silence transition is detected a detection significant flag is set 154 to “low.”

Then a detection routine is used to detect if there is a change in speakers 156. Routines for distinguishing between different speakers audio signature(s) are well known in the art. Alternative embodiments do not distinguish between speakers.

If there is a change in speakers 156 and the speaker mentions a number 158 a significance flag is set to high 160. Likewise if there is a change in speakers 154 and the speaker mentions a proper name 162, then a significance flag is set to high 164. Routines for recognizing numbers spoken in a digital audio signal are well known in the art. In alternative embodiments detection trigger significance flag settings may be raised even if there is no change in speaker preceding the mention of a number or proper name. In yet other alternative embodiments more complex triggers can be constructed using Grammar/Syntax parsers such as those described in U.S. Pat. No. 6,665,642.

In the embodiment shown in FIG. 5, the routine monitors for a user stop command 170. If a stop command is detected, the audio detection significance trigger flag value is reset to zero 172.

Although not shown in FIG. 5, audio detection trigger flag setting can be modified by other audio detection events. For example, even if there is no user instruction to begin recording 146, and there is no silence transition 152; and there is no change in speakers, 156, then the mention of key words may cause an increase in the detection trigger flag setting. Again, speech and syntax recognition routines are well known in the art to set off such a trigger flag significance level raising effect.

In the embodiment shown in FIG. 5, the detection flags are shown with only two settings. In alternative embodiments, a point system could be applied. In such a system different types of detections would have different values, the sum of which or combination of which are used by the main routine in FIG. 4 to determine whether the user should be prompted for instructions as to whether to proceed with recording. In other alternative embodiments the device would output different levels of prompts depending on the significance of the conversation or audio input detected the by the audio detection routine(s). These outputs supply information as to what was detected. Point values might depend on the order of the types of detections made. For example a pause followed by a change in speaker where the speaker mentions a number sequence may be given a very high significance value while a number sequence would be given a high significance value and one number may be given a low significance value.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A memory assistance recording method comprising:
(a) monitoring audio input for predetermined triggering events;
(b) notifying user of potentially recordable event;
(c) recording extended audio signal at user's instruction;
(d) prompting user to record a segment name for the extended audio signal; and
(e) recording the segment name linked to the extended audio signal.

2. The memory assistance recording system of claim 1 wherein the triggering events include a transition from silence.

3. The memory assistance recording system of claim 1 wherein the triggering events include an utterance of numbers.

4. The memory assistance system of claim 1 wherein the triggering events include an utterance of proper names.

5. The memory assistance recording method of claim 1 wherein the monitoring step monitors for triggering events which include include:
a transition from silence
an utterance of numbers; and
an utterance of proper names.

6. The memory assistance recording method of claim 1 wherein the monitoring step monitors for triggering events which include: an utterance of numbers; and an utterance of proper names.

7. A memory assistance system comprising a first data bank for storing audio recorded segment names and a second data bank for storing extended recorded audio segments wherein individual recorded audio segment names are linked to individual extended audio recorded segments.

8. A memory assistance system of claim 7 further comprising subsystems to monitor audio input and to prompt a user to begin recording a new extended audio segment.

9. The memory assistance recording system of claim 8 where the monitoring subsystems detect triggering events and prompt the user to begin recording a new extended audio recording upon triggering event detection.

10. The memory assistance recording system of claim 9 wherein the triggering events includes a transition from silence.

11. The memory assistance system of claim 9 wherein the triggering events include an utterance of proper names.

12. The memory assistance recording system of claim 9 wherein the triggering events include an utterance of numbers.

13. The memory assistance recording system of claim 9 wherein the triggering events include an utterance of proper names and an utterance of numbers.

14. the memory assistance recording system of claim 13 wherein the triggering events include a transition in speakers, the utterance of proper names and the utterance of numbers

15. Logic stored in memory for creating a databank of audio recordings comprised of:
(a) audio trigger detection routines;
(b) user prompt routine responsive to trigger detection routine and to user instructions;
(c) audio recording routine responsive to user instructions to record extended audio segments;
(d) user prompt routine responsive to the recording of an extended audio segment which prompts the user to record a segment name for the extended audio segment.
(e) logic for linking the recorded segment name to its extended audio segment for later retrieval.

16. The logic stored in memory of claim 15 where in the trigger detection routine detects a transition from silence.

17. The logic stored in memory of claim 15 where in the trigger detection routine detects an utterance of numerals.

18. The logic recorded in memory of claim 15 wherein the trigger detection routine detects an utterance of proper names.

19. The logic recorded in memory of claim 15 wherein the trigger detection routine detects transitions from silence and a transition in speakers.

20. The logic recorded in memory of claim 15 wherein the trigger detection routine detects an utterance of proper names and an utterance of numerals.
